(19) United States
(12) Patent Application Publication
(10) Pub. No.: US 2005/0247281 A1
(43) Pub. Date: Nov. 10, 2005

(54) Engine driving system

(76) Inventors: Kyoko HONBO, Hitachinaka (JP); Masanori Sakai, Hitachiota (JP); Mutsuhiro Mori, Mito (JP); Shinji Shirakawa, Hitachi (JP); Junichi Sakano, Hitachi (JP); Yasuo Kondo, Hitachinaka (JP); Tokiyoshi Hirasawa, Ogawa (JP); Masayuki Terada, Ide (JP); Takayuki Kimura, Nabari (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/168,461

(22) Filed: Jun. 29, 2005

Related U.S. Application Data
(62) Division of application No. 11/115,261, filed on Apr. 27, 2005.

(30) Foreign Application Priority Data
Apr. 28, 2004 (JP) 2004-133693

(51) Int. Cl. F02N 11/00

(52) U.S. Cl. 123/179.4; 290/50; 429/129

(57) ABSTRACT

Disclosed is an engine driving system having a cell suitable for restarting an engine, wherein an engine is stopped at the time of stopping running of a vehicle and the engine is restarted at the time of starting running of the vehicle, there are provided an engine electronic control device for controlling the engine, a motor for restarting the engine and a cell for supplying an electrical power to the motor; the cell comprises an anode plate formed into a thin band-shape, a cathode plate formed into a thin band-shape and a band-like separator arranged between the anode plate and the cathode plate; and the anode plate, the cathode plate and the separator form a group of wound pole plates and the group of pole plates is immersed in electrolysis solution.

### FIELD OF THE INVENTION

This invention relates to an engine driving system for stopping an operation of an engine under a running state stopped condition of a vehicle and restarting the engine when the vehicle starts running.

### BACKGROUND OF THE INVENTION

In recent years, there has been increasing in number a vehicle for employing an engine driving system for stopping an operation of an engine under a running stopped state of the vehicle at a crossing point or the like and restarting the engine when the vehicle starts to move in view of improvement of fuel efficiency or consideration of exhaust gas for ecological matter. As a system for restarting the engine, there are employed two types of system. One system is carried out for restarting the engine before the vehicle runs and starting it after the engine is operated. The other system is carried out for rotating the engine with a driving torque of the vehicle and restarting the engine by running the vehicle with a motor and, for connecting the driving unit of the vehicle with the engine after this operation.

In both systems, it becomes necessary to supply a high current to the motor for a short period of time so as to stop the operation of the engine once and restart the engine after the engine is stopped.

A sufficient capacitance could not be assured by the prior art battery installed on a vehicle because a large volume was required for assuring a capacitance of the battery. When a vehicle runs on the roads in Tokyo area having many installed signals, restarting of the engine is repeated within a short period of time, a severe consumption of electrical power of the battery occurs and further when stopping in operation of the engine under the stopped state of running is repeated, there occurs a possibility that restarting of the engine becomes difficult.

Due to this fact, when stopping running of the vehicle is repeated, stopping in operation of the engine is not carried out under a signal stopping state at the crossing point for avoiding a state in which restarting becomes difficult because of a lack of electrical power at the battery, but controlling for continuing the operation of the engine is performed. However, it is desirable that operation of the engine can be stopped as much as possible under a running stopped state of the vehicle in view of improvement of fuel efficiency or improvement of atmospheric contamination caused by exhaust gas.

In addition, there occurred a possibility that either an engine or a Diesel engine having a high displacement showed a high torque required when the engine was restarted, the prior art battery had an insufficient capacity and controlling of stopping in operation of the engine at the time of stopping of operation, the engine could not be restarted.

For example, there have been present some proposals for resolving such a problem as above as follows. There has been present a proposal that there are provided a starting battery device 1 for supplying an electrical power to a starter for rotationally driving the engine when the engine is started, a universal battery 2 for supplying an electrical power to a vehicle mounted equipment, an alternator 3 driven by the engine for use in charging the starting battery device 1 and the universal battery 2, a diode 8 (isolator) is arranged between a connecting point of the alternator 3 and the starting battery device 1 and the universal battery 2, the current from the universal battery 2 is prohibited when the starter 4 is started to operate and a charging circuit 9 of another system from power generating windings 3a, 3b, 3c installed at the alternator 3 is provided and then the universal battery 2 is charged. In Japanese Unexamined Patent Publication No. 118977/2002 (page 2, FIG. 1), another universal batter (a sub-battery) different from the starting battery is installed for performing a stable supplying of electrical power to some peripheral devices installed on the vehicle.

### SUMMARY OF THE INVENTION

For a fundamental resolution of the problem, it is necessary to improve a performance of a battery, i.e. a cell. For example, it is desired that the characteristics of the cell suitable for restarting of the engine are improved.

It is an object of the present invention to provide an engine driving system having a cell suitable for restarting the engine.

One means for resolving the aforesaid problem consists in the arrangement that an anode plate formed into a thin-plate band shape, a cathode plate formed into a thin-plate band shape and a separator arranged between the anode plate and cathode plate are wound to form a group of polarity plates and the group of polarity plates is immersed in electrolytic solution.

Another means for solving the above problem consists in the arrangement that an anode plate formed into a thin-plate band shape, a cathode plate formed into a thin-plate band shape and a separator arranged between the anode plate and cathode plate are wound to form a group of polarity plates and the group of polarity plates is immersed in electrolytic solution to constitute a cell and a plurality of cells are connected in series to constitute the cell.

As a practical solving means described in reference to the following preferred embodiments, the anode plate is constituted by a rolled sheet of Pb—Sn alloy, anode active substance paste is applied to front and rear surfaces of the sheet to apply a chemical processing to it.

In addition, an area of the anode plate is constituted to have a value of 9,000 to 162,000 cm².

Additionally, a content of Sn in Pb—Sn alloy constituting the anode plate is set to be 1.3 wt % or more and 2.3 wt % or less.

In addition, a thickness of the separator is set to 0.01 to 0.6 mm.

In addition, an area per unit volume is set to 1,700 to 30,000 cm²/cm³ under an estimation that an area of the anode plate in the cell is 1,500 to 27,000 cm² and the maximum outer shape size of the cell is applied as a rectangular parallelepiped.

In addition, a content of Sn in Pb—Sn alloy constituting the anode plate is set to be 1.3 wt % or more and 2.3 wt % or less.

Additionally, a thickness of the separator is se to 0.01 to 0.6 mm.

The engine driving system of the present invention enables an electrical characteristic for restarting the engine to be improved and further enables a superior restarting system to be provided.

### BRIEF DESCRIPTION OF THE DRAWINGS

FIG. 1 is a schematic view for showing a state in which one preferred embodiment of an engine driving system using a lead-acid battery is installed at an automobile.

FIG. 2 is a detailed block diagram for showing a control system for a transmission power transmitted to the power transmission mechanism and the driving system in FIG. 1.

FIG. 3 is a configuration view for showing a lead-acid battery used in an engine driving system shown in FIG. 1.

FIG. 4 is a view for showing a wound type battery constituted by one cell wound in a spiral wound and formed into a column-like shape.

FIG. 5 is a view for showing a wound type battery constituted by one cell wound in a rectangular spiral wound and formed into a prism shape.

FIG. 6 is a view for showing the third preferred embodiment of a wound type battery used in the engine driving system of the present invention.

FIG. 7 is a view for showing a current-voltage characteristic of a wound type battery shown in FIG. 6.

FIG. 8 is a view for showing a current-voltage characteristic of a wound type battery of the fourth preferred embodiment.

FIG. 9 is s view for showing an output characteristic after overcharge at 75° C. of a wound type battery of the fifth preferred embodiment.

FIG. 10 is a view for showing the first example of comparison of a wound type battery used in the engine driving system of the present invention.

FIG. 11 is a view for showing a configuration view of the engine driving system using the wound type battery shown in FIG. 10.

FIG. 12 is a control flow chart at the time of idling stop mode at the power transmission mechanism shown in FIG. 2.

### DETAILED DESCRIPTION OF THE INVENTION

In the preferred embodiments of the present invention, an electrical power is supplied to a motor for rotationally driving an engine when the engine is restarted, as a power supply for supplying an electrical power to the peripheral device installed on a vehicle, the anode plate and the cathode plate are provided with a group of pole plates wound through a separator and there is provided one wound lead-acid battery immersed in the electrolysis solution and capable of keeping a terminal voltage of 10 V or more.

As described above, the present invention enables a stable electrical power to be supplied to both a starter motor and automobile installed devices even if an idling stop is frequently generated during running of an automobile because one battery installed in a space of the prior art engine room is constituted by one lead-acid cell without installing any new power supply for a load (the starter motor).

### Embodiment 1

One preferred embodiment will be described in detail as follows.

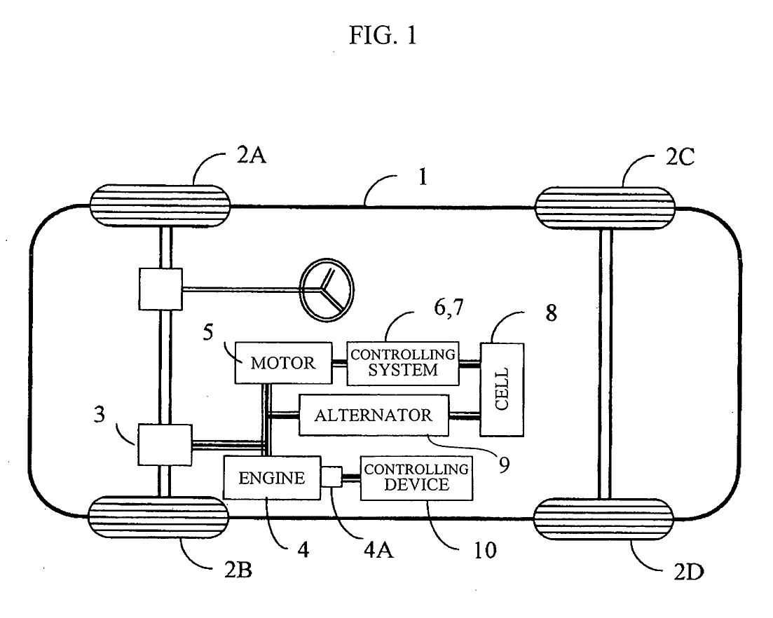

In FIG. 1 is illustrated a schematic view for showing a state in which one preferred embodiment of the engine driving system using the lead-acid battery of the present invention is installed in an automobile.

In FIG. 1, a vehicle 1 is provided with front and rear four wheels 2A, 2B, 2C and 2D, wherein the front two wheels 2A, 2B of the four wheels 2A, 2B, 2C and 2D are driven by a power transmission mechanism 3. The front two wheels 2A, 2B are driven by a torque generated by the engine 4. The engine 4 is controlled by a control device 10 and energized with a starter motor 4A. This starter motor 4A is a motor for use in starting the engine when the engine is kept at its cool state, for example, this is a starter motor usually used.

In addition, a motor 5 is used for restarting the engine stopped as the vehicle running is stopped for a short period of time such as one waiting for a time in which a signal is changed at a crossing point. Controlling of this motor 5 is performed by a motor system control unit 6, and the motor system control unit 6 controls the motor 5 through a motor driving circuit 7. When the engine of the automobile is driven again after the automobile stops once, the engine can be started through two systems. The first system is one in which the engine is restarted with the motor 5 in a state where the vehicle is stopped, and the running is started with the engine started again. In addition, the second system is one in which after the operation of the engine is stopped when the running of the vehicle is stopped, the vehicle is at first run with the motor 5 before restarting of the engine, and the engine is connected to the vehicle driving system after the vehicle is run, the torque is transmitted to the vehicle driving system and then the engine is restarted with this torque. The first system has a merit in which the restarting can be performed by a small-sized motor and a relative low cell capacitance. In turn, the second system has a merit in which an adhesion of supplied fuel at the wall surface can be reduced and a discharging of hydro-carbon can be reduced because a rotational speed of the engine at the time of restarting operation can be increased and an amount of supplied air at the engine can be increased.

Restarting of the engine through the first system will be described as follows. Operation of the engine is stopped through the idling stop mode in which the running of the automobile is stopped, then, when the idling stop mode of the automobile is released, the engine and the power transmission mechanism 3 for driving the wheels 2A, 2B are separated from each other by an electric clutch not shown. When the motor 5 is driven by the motor system control unit 6 through the motor driving circuit 7, the motor rotates the engine and at first restarts the engine, then the engine is connected to the power transmission mechanism 3 for driving the wheels 2A, 2B through an electric clutch not shown, a torque of the engine is transmitted to the wheels 2A, 2B and the vehicle starts to run.

Then, the second system will be described. Operation of the engine is stopped under an idling stop mode through the stopped running of the automobile. The motor 5 is mechanically connected to the power transmission mechanism 3 and when the motor 5 is driven by the motor system control unit 6 and the motor driving circuit 7 under a released state of the idling stop mode of the automobile, a rotational torque is transmitted to the two wheels 2A, 2B through the power transmission mechanism 3 and the automobile starts to move through driving of the motor 5. As the automobile runs, the engine is mechanically connected to the power transmission mechanism 3, and the engine starts to rotate. Accordingly, when both fuel and igniting energy are supplied to the engine, the engine restarts to operate. When the engine and the power transmission mechanism are always connected, restarting of the engine can be started along with a starting of rotation of the motor 5. If supplying of both fuel and ignition energy is carried out after waiting for an increasing of the rotational speed of the engine, restarting of the engine is delayed. However, since the engine can be started in a state where the rotational speed of the engine is kept high, discharging of hydro-carbon can be reduced.

In the aforesaid first and second systems, the driving energy for the motor is supplied from a cell 8.

A starter motor 4A in this figure is a starter motor for use in starting the engine under its low temperature state as described above. The starter motor 4A and the engine 4 are controlled by the control unit 10 and the requisite energy is supplied from the lead-acid battery 8. The lead-acid batter 8 is charged with an alternator 9 driven by the engine 4.

During driving operation, a driver's instruction is detected by an accelerator sensor (detecting an accelerator treading amount) to control an output of the engine 4.

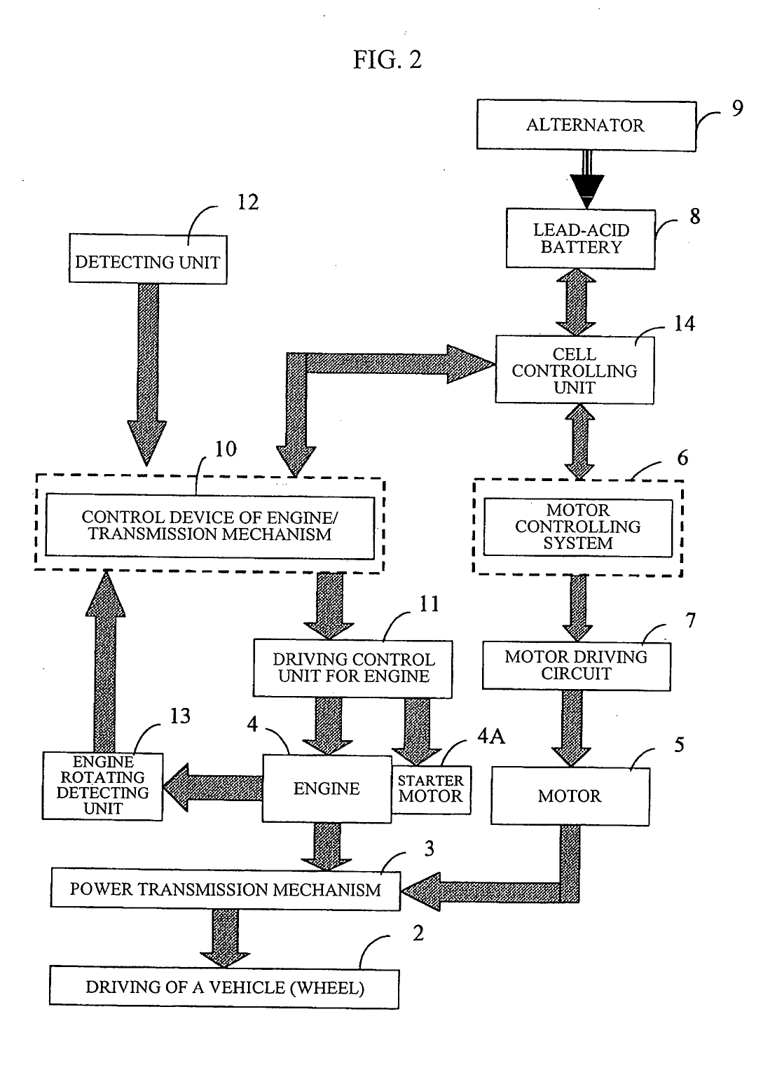

In FIG. 2 is shown a detailed block diagram for a control system for transmission force to be transmitted to the power transmission mechanism 3 and the driving system in FIG. 1.

In FIG. 2, an engine driving shaft for transmitting a driving force (a torque) of the engine 4 and a motor driving shaft for transmitting the driving force (the torque) of the motor 5 are connected to the power transmission mechanism 3 for driving the wheels 2A, 2B, 2C and 2D for running the vehicle. In addition, the engine 4 is provided with the starter motor 4A and when the engine 4 is kept in its cooled state, the engine 4 is not started unless a certain degree of rotating force is applied, so that the starter motor 4A is operated after turning on a key switch and the engine 4 is energized. This starter motor 4A is controlled by the control unit 10.

A controlling instruction for the motor 5 is generated at the motor system control unit 6 and the controlling instruction from the motor system control unit 6 is transmitted to a motor driving circuit 7. The motor driving circuit 7 is an inverter for converting a DC energy from a DC power supply to an AC energy, and the AC energy generated at the inverter is supplied to a stator winding of the motor 5. A rotating magnetic field is generated in the motor with this AC current and a rotating torque is generated at a rotor of the motor 5 provided with a permanent magnet. A high torque is necessary for starting the engine and current supplied to the stator becomes a large current. Supplying of current is not required for the rotor provided with the permanent magnet and no rectifier is required, so that the permanent type rotary synchronous motor is the most suitable starting motor for the engine. In addition, although the alternator 9 for use in generating an electrical energy is arranged in the preferred embodiment, it may also be used as a power generator by applying the engine starting motor 5 as the permanent magnet type synchronous motor. When it is used as a power generator in this way, the generated AC current can be rectified by the inverter of the motor driving circuit and then DC energy can be supplied to the battery 8. Further, although the rectifier for the rotor is eliminated in the foregoing description, an exciting magnetic flux can be generated at the rotor by the aforesaid winding in addition to the permanent magnet by arranging both the rectifier and the winding to the rotor and by supplying the exciting current from the aforesaid rectifier to the winding, and controlling the exciting current in the rotor winding enables the generated voltage to be controlled.

A detecting unit 12 and a cell control unit 14 are connected to the control unit 10 for the engine/transmission mechanism. In addition, an engine rotation detecting unit 13 is connected to the control unit 10 for the engine/transmission mechanism. This detecting unit 12 performs a detection requisite for a controlling of the engine 4 and the driving transmission mechanism 3. Major information detected by the detecting unit 12 are an accelerator operating amount Pa, an intake air amount Qa supplied to the engine, a rotational speed Ne of the engine, an engine cooling water temperature T_{W}, an air-fuel ratio detected in reference to the exhausting state, a vehicle speed Vs and other information used for a diagnosis and the like.

In addition, the control unit 10 for the engine/transmission mechanism calculates a request torque for the vehicle from the vehicle speed Vs or the rotational speed Ne of the engine in response to the operating amount Pa of the accelerator.

The engine controlling unit 11 is a mechanism for performing control under an opened state of a throttle valve, control over a valve opening timing of the intake valve or a valve opening amount, control over an ignition time, control over a valve opening timing for an exhaust valve or control over an opened valve amount, and control over a returning flow rate of exhaust gas, and then a degree of opening of the throttle valve or a valve opening angle of the intake valve or a lift amount of the opened valve is controlled in response to a requested torque TD. An amount of air Qa supplied to the engine 4 is changed under this control. The amount of air Qa supplied to the engine 4 is detected by the detecting unit 12 and the fuel supplying amount against the amount of air Qa is calculated.

In addition, an ignition time is defined in response to the rotating speed Ne of the engine and a basic fuel amount (Qa/Ne). Calculation of these control amounts is performed at the control unit 10 for the engine/transmission mechanism, and the driving control unit 11 for the engine is controlled by the calculated controlling amount and the engine 4 generates a torque. In addition, the control unit 10 for the engine/transmission mechanism is used for detecting it through the engine rotation detecting part 13 whether or not the engine 4 is being rotated, i.e. whether or not the front two wheels 2A, 2B are being rotated by the power transmission mechanism 3 through driving of the motor 5 after the idling stop mode is released. When it is detected by the engine rotation detecting unit 13 that the engine 4 is being rotated, the control unit 10 for the engine/transmission mechanism operates an electronic fuel injection device to energize the engine 4.

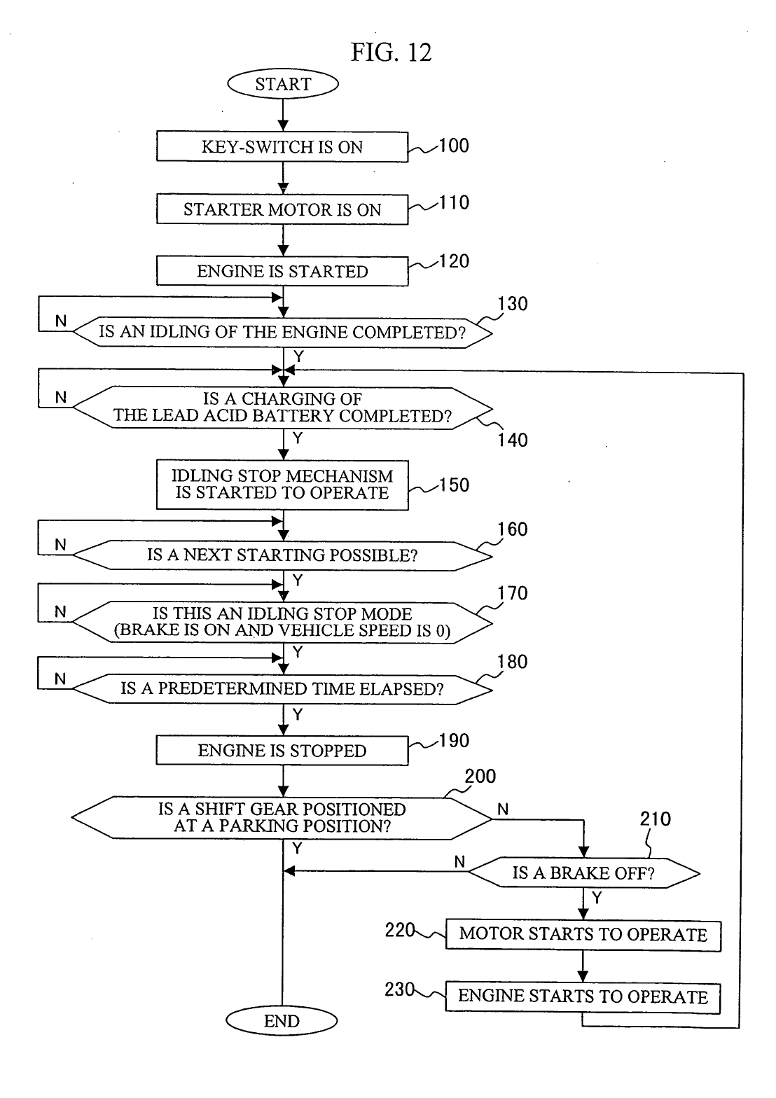

Referring to a flowchart of FIG. 12, controlling operation at the time of idling stop mode will be described as follows.

When a starting operation of the engine at the vehicle 1 is started, an ignition key is turned ON at a step 100. At this step 100, when the ignition key is turned ON, a current is supplied to the starter motor 4A at a step 110 and the engine 4 is rotated. At this step 110, when the starter motor 4A is driven, the engine 4 starts to operate at a step 120. In a state where a temperature of the engine 4 is low, its load is high and it is so hard to perform the operation only with the electric motor and so the engine 4 is not started unless a cranking is set with the starter motor 4A. Then, at the time of initial starting operation of the vehicle 1, the engine 4 is started to operate with the starter motor 4A.

When the engine 4 starts to operate at this step 120, an idling operation is started to discriminate whether or not the idling of the engine 4 is completed at the step 130. The idling state of the engine 4 is carried out by a cooling water temperature sensor for the engine. When the engine 4 becomes an idling state, the cooling water temperature of the engine is increased, so that it is discriminated by the temperature of the cooling water. At this step 130, it is waited until the idling operation of the engine is completed. At this step 130, when it is discriminated that the idling operation of the engine 4 is completed, it is discriminated at a step 140 whether or not a charging of the lead-acid cell 8 by the alternator 9 is sufficient. The lead-acid cell 8 is charged with the alternator 9 when its capacitance is lower than a certain reference value, and during this charging operation, its output electrical power is not sufficient and a power for driving the motor 5 to move the vehicle 1, so that the idling stop control is not carried out even if the running speed of the vehicle becomes zero or near zero under the idling stop mode, i.e. a state where a brake pedal is treaded. That is, at this step 140, it is checked whether or not an electromotive force of the lead-acid cell 8 is sufficient. If the electromotive force of the lead-acid cell 8 is not sufficient, the idling stop control is not carried out when the charging is being performed by the alternator 9 because the charging is performed by the alternator 9.

At this step 140, when it is discriminated that the charging of the lead-acid cell 8 is completed by the alternator 9, i.e. the electromotive force of the lead-acid cell 8 is sufficient, the idling stop mechanism is started to operate at the step 150. That is, the idling stop control is carried out. At this step 150, when the idling stop mechanism starts to operate, the engine 4 once stopped is operated at a step 160 to move the vehicle 1 through the motor 5 and it is discriminated whether or not the engine can be started to operate. At this step 160, it is discriminated whether or not the engine 4 once stopped can be started through the aforesaid first or second system. When it is discriminated that the engine can be started to operate, it is discriminated at a step 170 whether or not the mode becomes an idling stop mode (ON of the brake and the vehicle speed of “0”). At the step 160, it is discriminated whether or not a next start can be carried out, and after the starting operation becomes possible, it is waited until the mode becomes the idling stop mode (ON of the brake and the vehicle speed of “0”). At this step 170, when it is discriminated that the mode is changed to the idling stop mode (a state in which a brake is ON and the vehicle speed is “0”), at the step 180, it is discriminated whether or not a predetermined time elapses after the mode is changed into the idling stop mode. Although the predetermined time is different at each of the automobile makers, this is normally a time of 30 seconds or one minute after the mode is changed into a mode where the brake is ON and the vehicle speed is “0”.

At this step 180, when it is discriminated that a predetermined time elapsed from the idling stop mode, an idling stop control is carried out and at the step 190, the engine 4 stops. At this step 190, when the engine 4 stops, at a step 200, it is discriminated whether or not the position of a shift gear is a parking (P) position. At this step 200, when it is discriminated that the position of the shift gear is at the parking position (P), the idling stop control is not carried out and this flow finishes. In addition, at this step 200, when it is discriminated that the position of the shift gear is not the parking (P) position, at a step 210, it is discriminated whether or not the brake is OFF. At this step 210, when it is discriminated that the brake is OFF, this flow is finished, i.e. the engine is restarted. In addition, at this step 210, when it is discriminated that the brake is not OFF, at a step 220, it is discriminated whether or not the brake is changed from ON to OFF. At this step 220, when it is discriminated that the brake is changed from ON to OFF, at this step 220, it is discriminated whether or not the brake is changed from ON to OFF. At this step 230, the motor 5 is started to operate. When this motor 5 starts to operate, the vehicle 1 starts to move, and when the engine 4 rotates, rotation of the engine 4 is detected by the engine rotation detecting unit 13, the electronic fuel injection device is driven and at a step 240, the engine 4 starts to operate. At this step 240, when the engine 4 starts to operate, the operation returns to the step 140 and again the idling stop control is carried out.

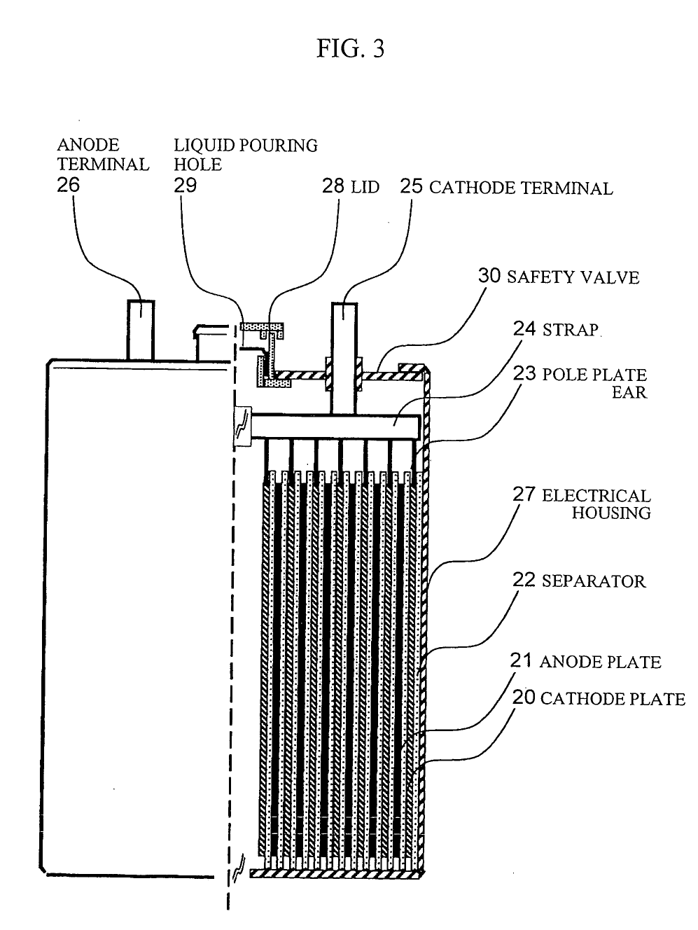

The lead-acid cell 8 used in the engine driving system shown in FIG. 1 has a configuration shown in FIG. 3.

The lead-acid cell 8 shown in FIG. 3 is constituted by a cell of the wound type lead cell. A cell of this wound lead-acid cell is manufactured by the following method. That is, at first, the cathode plate 20 and the anode plate 21 are wound into a spiral form through a separator 22 having a thickness of 0.4 mm, they are left at a temperature of 50° C. and a humidity of 95% for 18 hours and ripened there, and then they are left at a temperature of 110° C. for two hours and dried. After this operation, ten pole plate ears 23 of the same polarity are connected to each other by straps 24, each of the straps 24 at each of the poles is welded to the cathode terminal 25 and the anode terminal 26 to make a group of wound elements. This is installed in a cell housing 27, a lid 28 is applied on the upper part of the housing, adhered, electrolysis solution of dilute sulfuric acid with a specific gravity 1.2 (20° C.) is poured at a liquid pouring port 29 to make a non-chemically-converted cell. After this cell is processed at 9 A for 20 hours, solution of dilute sulfuric acid with a specific gravity 1.4 (20° C.) is added to it for adjustment to attain electrolysis sulfuric acid solution with a concentration of specific gravity 1.3 (20° C.). A safety valve 30 is installed there to attain the cell.

A cathode 20 at the lead-acid battery 8 formed by the cell of the wound type lead-acid battery shown in FIG. 3 is manufactured such that a cathode assembly is manufactured at first, a cathode active substance paste is applied to coat both front and rear surfaces of the cathode assembly to make a non-chemically-converted cathode plate 20.

The cathode assembly is constituted such that after alloy containing Sn of 5 wt % is melted in Pb, the alloy is cold rolled to make a rolled sheet with a thickness of 0.2 mm.

Cathode active paste is a substance made such that a mixture attained by mixing and kneading lignin of 0.3 wt %, barium sulfate or strontium sulfate of 0.2 wt %, carbon powder of 0.1 wt % and balance of lead powder with a mixing and kneading machine for about ten minutes is added with water of 12 wt %, mixed and kneaded and further the mixed and kneaded powder is added with dilute sulfuric acid of 13 wt % having a specific gravity 1.26 at 20° C. and they are mixed and kneaded to each other.

The non-chemically-converted cathode plate 20 is an item made in such a way that cathode active paste of 45 g is applied to coat both surfaces of the cathode assembly composed of alloy foil containing Sn of 11.5 wt % to Pb with a thickness of 0.2 mm under application of the cathode assembly and the cathode active substance paste and molded into an item having a thickness of 0.8 mm.

The anode assembly is constituted such that after alloy containing Sn of 1.5 wt % in Pb is melted, the material is cold rolled to make a rolled sheet with a thickness of 0.2 mm.

The anode active substance paste is a substance similar to the cathode active substance paste made such that a mixture attained by mixing and kneading lignin of 0.3 wt %, barium sulfate or strontium sulfate of 0.2 wt %, carbon powder of 0.1 wt % and balance of lead powder with a mixing and kneading machine for about ten minutes is added with water of 12 wt %, mixed and kneaded and further the mixed and kneaded lead powder is added with dilute sulfuric acid of 13 wt % having a specific gravity 1.26 at 20° C. and they are mixed and kneaded to each other.

The non-chemically-converted anode plate 21 is an item made such that the anode active substance paste of 45 g is applied to coat on both surfaces of the anode assembly composed of a foil of alloy of Pb—Sn having a thickness of 0.2 mm under application of the anode assembly and the anode active substance paste and molded to have a thickness of 0.8 mm.

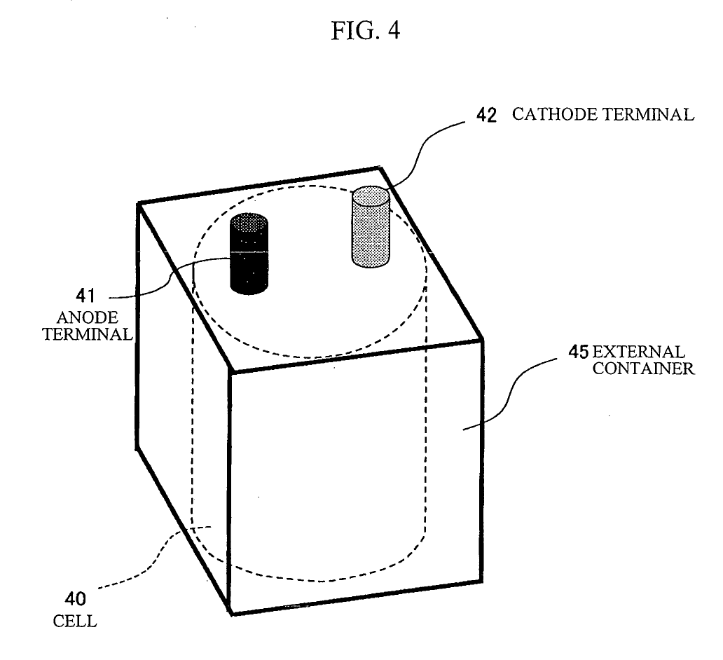

A wound type cell shown in FIG. 4 is one cell made such that the cathode plate 20 and the anode plate 21 are wound in a spiral form through the separator 22 as shown in the wound type cell illustrated in FIG. 3 and formed into a column-like shape. Even if the cell is constituted by one cell, this cell is set such that it has a characteristic having a function for outputting a voltage of 10 V or more even if a current of at least 400 A is outputted. In addition, an area of the anode plate 21 constituting the wound type cell shown in FIG. 4 is formed to have a value of 9,000 to 162,000 cm². In addition, both the cathode assembly and the anode assembly constituting the wound type cell shown in FIG. 4 are made of Pb—Sn alloy and a content of Sn is set in a range of 1.3 wt % or more to 2.3 wt % or less. Further, a thickness of the separator 22 present between the cathode plate 20 and the anode plate 21 constituting the wound type cell shown in FIG. 4 is set to 0.01 to 0.6 mm.

### Embodiment 2

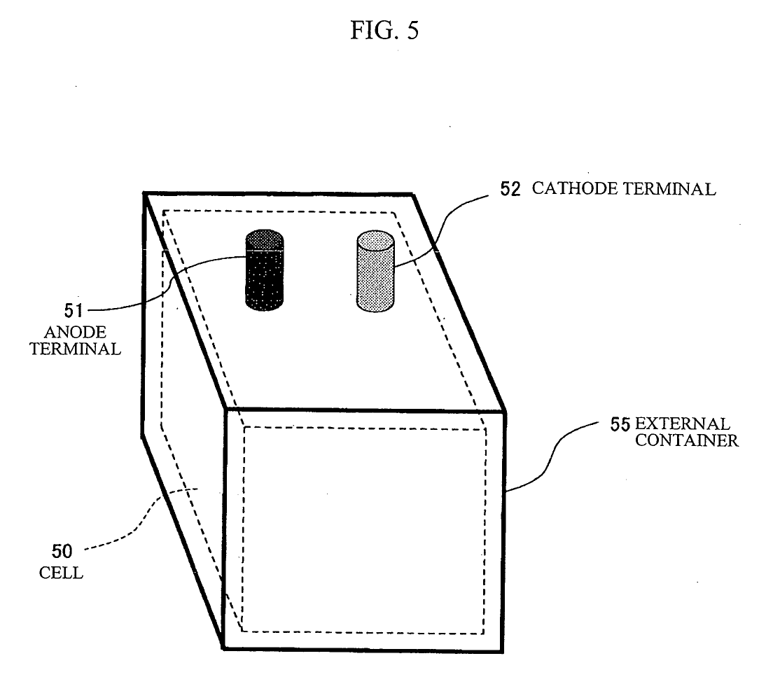

In FIG. 5 is shown the second preferred embodiment of the wound type cell used in the engine driving system of the present invention.

The wound type cell shown in FIG. 5 is not constituted by one column-like cell formed by winding the cathode plate 20 and the anode plate 21 through the separator 22 into a spiral form as shown in the wound type cell in FIG. 3, but constituted by one cell formed into a pyramid shape in which the cell housing 27 constituting the cell is formed into a rectangular shape, the cathode plate 20 and the anode plate 21 are wound along the rectangular cell housing 27 through the separator 22 into a rectangular spiral form. Such a formation as above enables the useless space to be eliminated as compared with that of the wound type cell shown in FIG. 4 and provides a more efficient manufacturing of the cell. The wound type cell shown in FIG. 5 also shows that this cell is set to have a characteristic having a function for outputting a voltage of 10 V or more even if a current of at least 400 A is outputted. In addition, an area of the anode plate 21 constituting the wound type cell shown in FIG. 5 is formed to have a value of 9,000 to 162,000 cm². In addition, both the cathode assembly and the anode assembly constituting the wound type cell shown in FIG. 5 are made of Pb—Sn alloy and a content of Sn is set in a range of 1.3 wt % or more to 2.3 wt % or less. Further, a thickness of the separator 22 present between the cathode plate 20 and the anode plate 21 constituting the wound type cell shown in FIG. 5 is set to 0.01 to 0.6 mm.

### Embodiment 3

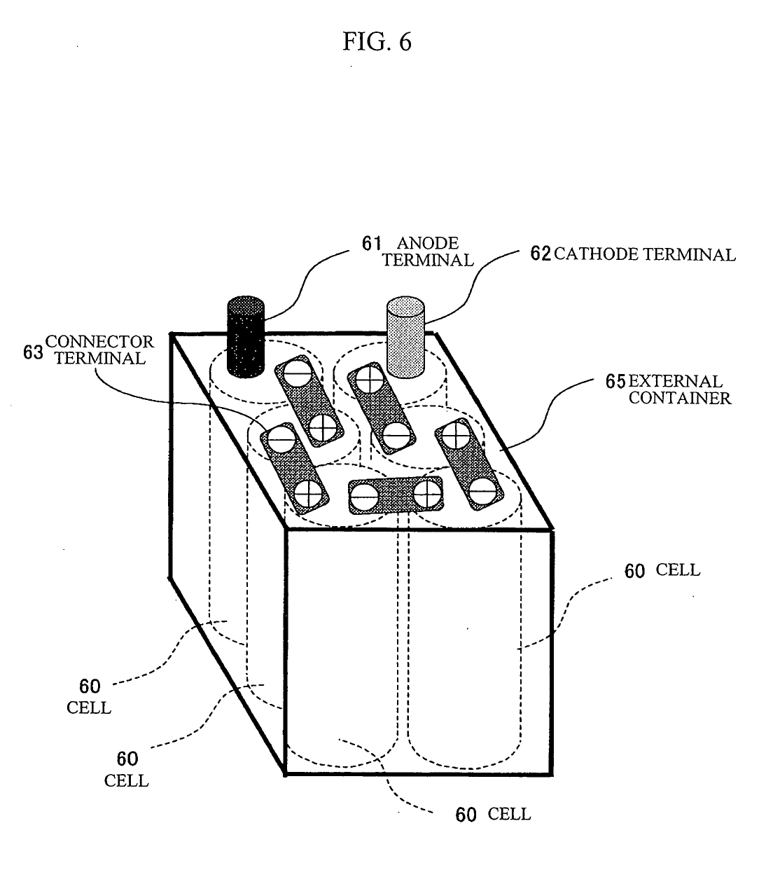

In FIG. 6 is shown the third preferred embodiment of the wound type cell used in the engine driving system of the present invention.

The wound type cell shown in FIG. 6 is constituted such that six cells 60 having the cathode plate 20 and the anode plate 21 as illustrated in the wound type cell shown in FIG. 3 wound in a spiral form through the separator 22 are connected in series by connector terminals 63 and then they are mounted at an outer container 65 provided with an anode terminal 61 and a cathode terminal 62. A design capacitance of the wound type cell shown in FIG. 6 is 28 Ah and an average discharging voltage is 12V. Additionally, the maximum outer size of the wound type cell shown in FIG. 6 is similar to 38B19 under an estimation of applying a rectangular parallelepiped, and a cell volume is 5.4 dm³. A total area of the electrode at the anode plate 21 of the wound type cell shown in FIG. 6 is 10,800 cm², an anode area per volume of the wound type lead-acid battery is 2,000 cm²/dm³ and an area of the anode per cell is 1,800 cm².

Then, the wound type cell shown in FIG. 6 is also set to have a characteristic with a function for outputting a voltage of 10 V or more even if a current of at least 400 A is outputted. In addition, both the cathode assembly and the anode assembly constituting the wound type cell shown in FIG. 6 are made of Pb—Sn alloy, wherein a content of Sn is 1.3 wt % or more and 2.3 wt % or less. Further, a thickness of the separator 22 present between the cathode plate 20 and the anode plate 21 constituting the wound type cell shown in FIG. 6 is set to 0.01 to 0.6 mm.

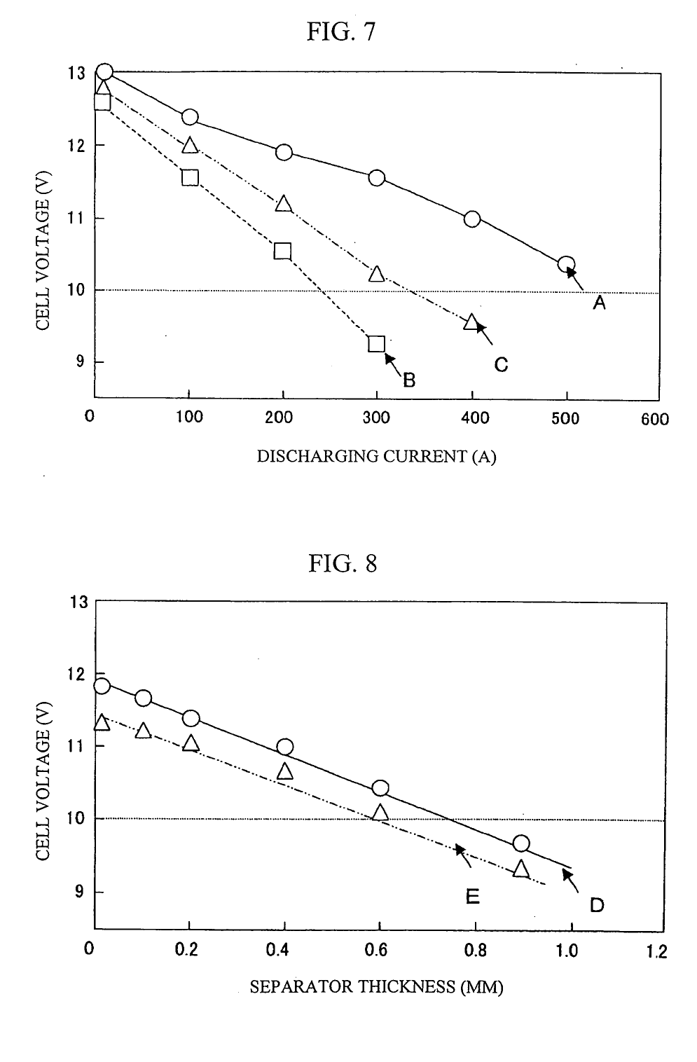

A current-voltage characteristic of the wound type cell shown in FIG. 6 has a characteristic shown in FIG. 7. That is, the current-voltage characteristic shown in FIG. 7 is attained such that a terminal voltage of the cell is measured under application of a charging/discharging device when the electrical discharging is carried out for one second from a full charged state while the discharging current is changed in a range from 100 to 500 A.

At a graph A in FIG. 7 is indicated a current-voltage characteristic of the wound type lead-acid battery of the preferred embodiment 3. The graph A in FIG. 7 is made such that a terminal voltage of the cell when this is discharged for one second from the full-charged state while the discharging current is changed from 100 to 500 A. The graph A in FIG. 7 shows that the terminal voltage of the cell at one second is 10 V or more even if the wound type cell shown in FIG. 6 is discharged at a high discharging current of 500 A and the cell has a superior output performance.

In addition, an over-charging test that is the most severe life test under an assumption of a high temperature environment when the wound type cell shown in FIG. 6 is installed at an engine room was carried out. As for the wound type cell shown in FIG. 6, 56 cycles (28 days) were repeated in which a constant current and constant voltage charging with a charging current of 5.6 A and an upper limit voltage of 14V at 75° C. is carried out for six hours for the wound type cell shown in FIG. 6 and a rest time for six hours is set after discharging of high current for one second at 400 A. After this test, the temperature was set to a room temperature and a discharging was carried out at 500 A and the terminal voltage of the cell at the first second was measured. The wound type lead-acid battery of the preferred embodiment 3 shown in FIG. 6 enabled the terminal voltage of the cell to keep 10 V or more and it has been made apparent that it has a superior output performance even after the over-charging cycle at 75° C.

The engine driving system using the wound type lead-acid battery of the preferred embodiment 3 shown in FIG. 6 is operated such that the engine 4 is stopped at the time of stopping for a red signal or a contemporary stopping and the engine is restarted with a motor when the vehicle starts to move in reference to improvement of a fuel consumption or a counter-measure of exhaust gas against global environment. When the wound type lead-acid battery of the preferred embodiment 3 shown in FIG. 6 is applied, a current is also flowed to an electrical load of the peripheral device installed on the vehicle in concurrent with supplying of current to the starter motor when it is restarted. In view of this fact, when the terminal voltage of the wound type lead-acid battery of the preferred embodiment 3 shown in FIG. 6 at the time of energization of the engine after idling operation under application of the idling stop system having the wound type lead-acid battery of the preferred embodiment 3 shown in FIG. 6 was measured, it was made apparent that the terminal voltage of the wound type lead-acid battery of the preferred embodiment 3 shown in FIG. 6 was 10 V or more and it was possible to keep the voltage where the peripheral device installed on the vehicle such as an audio system or the like is not stopped.

### Embodiment 4

Then, the fourth preferred embodiment of the wound type cell used in the engine driving system of the present invention will be described as follows. Configuration of the wound type cell is similar to that of the wound type cell of the third preferred embodiment shown in FIG. 6.

The wound type cell of the fourth preferred embodiment is constituted such that the cathode plate 20 and the anode plate 21 are wound in a spiral form through the separator 22 as indicated in the wound type cell shown in FIG. 3, six cells 6 formed in a column-like manner are connected in series by the connecting terminals 63 and then they are mounted at the outer container 65 provided with the anode terminal 61 and the cathode terminal 62. A design capacitance of the wound type cell of the fourth preferred embodiment is 24 to 34 Ah and an average discharging voltage is 12V. Additionally, the maximum outer size of the wound type cell of the fourth preferred embodiment is similar to 38B19 under an estimation of applying a rectangular parallelepiped, and a cell volume is 5.4 dm³. A total area of the electrode at the anode plate 21 of the wound type cell of the fourth preferred embodiment is 9,300 to 160,000 cm², an anode area per volume of the wound type lead-acid battery is 1,700 to 30,000 cm²/dm³ and an area of the anode per cell is 1,500 to 27,000 cm².

Then, the wound type cell of the fourth preferred embodiment is also set to have a characteristic with a function for outputting a voltage of 10 V or more even if a current of at least 400 A is outputted. In addition, both the cathode assembly and the anode assembly constituting the wound type cell of the fourth preferred embodiment are made of Pb—Sn alloy, wherein a content of Sn is 1.3 wt % or more and 2.3 wt % or less. Further, a thickness of the separator 22 present between the cathode plate 20 and the anode plate 21 constituting the wound type cell of the fourth preferred embodiment is set to 0.01 to 0.6 mm.

A current-voltage characteristic of the wound type cell of the fourth preferred embodiment has a characteristic shown in FIG. 8. That is, the current-voltage characteristic shown in FIG. 8 evaluated the current-voltage characteristic of the wound type lead-acid battery in the same manner as that of the preferred embodiment. That is, the characteristic shown in FIG. 8 indicates that a discharging of 400 A of the wound type lead-acid battery and the terminal voltage of the cell at the first second of the embodiment 4 are indicated at a graph D of FIG. 8. The terminal voltages of the wound type cell of the fourth preferred embodiment are 10 V or more and it is apparent that they have a superior output performance.

In addition, an over-charging test that is the most severe life test under an assumption of a high temperature environment when the wound type cell of the fourth preferred embodiment is installed at an engine room was carried out. An output characteristic after over-charging at 75° C. is indicated at a graph E in FIG. 8. As for the over-charging test at 75° C. at the graph E in FIG. 8, 56 cycles (28 days) were repeated in which a constant current and constant voltage charging with a charging current of 5.6 A and an upper limit voltage of 14V at 75° C. is carried out for six hours for the wound type cell of the fourth preferred embodiment and a rest time for six hours is set after discharging of high current for one second at 400 A. After this test, the temperature was set to a room temperature and a discharging was carried out at 500 A and the terminal voltage of the cell at the first second was measured. The wound type lead-acid battery of the fourth preferred embodiment enabled the terminal voltage of the cell to keep 10 V or more and it has been made apparent that it has a superior output performance even after the over-charging cycle at 75° C.

The engine driving system using the wound type lead-acid battery of the preferred embodiment 4 is operated such that the engine is stopped at the time of stopping for a red signal or a contemporary stopping and the engine is restarted with a motor when the vehicle starts to move in reference to improvement of a fuel consumption or a counter-measure of exhaust gas against global environment. When the wound type lead-acid battery of the preferred embodiment 4 is applied, a current is also flowed to an electrical load of the peripheral device installed on the vehicle in concurrent with supplying of current to the starter motor when it is restarted. In view of this fact, when the terminal voltage of the wound type lead-acid battery of the preferred embodiment 4 at the time of energization of the engine after idling operation under application of the idling stop system having the wound type lead-acid battery of the preferred embodiment 4 was measured, it was made apparent that the terminal voltage of the wound type lead-acid battery of the preferred embodiment 4 was 10 V or more and it was possible to keep the voltage where the peripheral device installed on the vehicle such as an audio system or the like is not stopped.

### Embodiment 5

Then, the fifth preferred embodiment of the wound type cell used in the engine driving system of the present invention will be described as follows. Configuration of the wound type cell is similar to that of the wound type cell of the third preferred embodiment shown in FIG. 6.

The wound type cell of the fifth preferred embodiment is constituted such that the cathode plate 20 and the anode plate 21 are wound in a spiral form through the separator 22 as indicated in the wound type cell shown in FIG. 3, six cells 6 formed in a column-like manner are connected in series by the connecting terminals 63 and then they are mounted at the outer container 65 provided with the anode terminal 61 and the cathode terminal 62. A design capacitance of the wound type cell of the fifth preferred embodiment is 28 Ah and an average discharging voltage is 12V. Additionally, the maximum outer size of the wound type cell of the fifth preferred embodiment is similar to 38B19 under an estimation of applying a rectangular parallelepiped, and a cell volume is 5.4 dm³. A total area of the electrode at the anode plate 21 of the wound type cell of the fifth preferred embodiment is 10,800 cm², an anode area per unit volume of the wound type lead-acid battery is 2,000 cm²/dm³ and an area of the anode per cell is 1,800 cm².

Then, the wound type cell of the fifth preferred embodiment is also set to have a characteristic with a function for outputting a voltage of 10 V or more even if a current of at least 400 A is outputted. In addition, both the cathode assembly and the anode assembly constituting the wound type cell of the fifth preferred embodiment are made of Pb—Sn alloy, wherein a content of Sn is 1.3 wt % or more and 2.3 wt % or less. Further, a thickness of the separator 22 present between the cathode plate 20 and the anode plate 21 constituting the wound type cell of the fifth preferred embodiment is set to 0.01 to 0.6 mm.

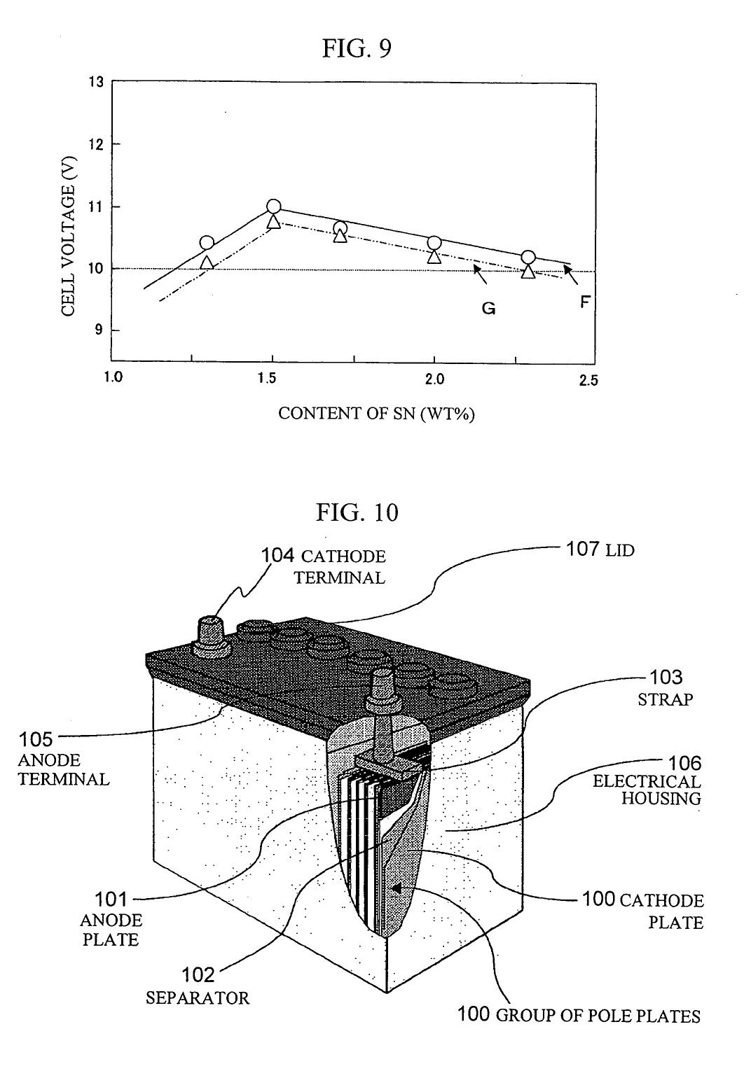

A current-voltage characteristic of the wound type cell of the fifth preferred embodiment has a characteristic shown in FIG. 8. That is, the current-voltage characteristic shown in FIG. 9 evaluated the current-voltage characteristic of the wound type lead-acid battery in the same manner as that of the preferred embodiment. That is, the characteristic shown in FIG. 9 indicates that a discharging of 500 A of the wound type lead-acid battery and the terminal voltage of the cell at the first second of the embodiment 5 are indicated at a graph F of FIG. 9. The terminal voltages of the wound type cell of the fifth preferred embodiment are 10 V or more and it is apparent that they have a superior output performance.

In addition, an over-charging test that is the most severe life test under an assumption of a high temperature environment when the wound type cell of the fifth preferred embodiment is installed at an engine room was carried out. An output characteristic after over-charging at 75° C. is indicated at a graph G in FIG. 9. As for the over-charging test at 75° C. at the graph G in FIG. 9, 56 cycles (28 days) were repeated in which a constant current and constant voltage charging with a charging current of 5.6 A and an upper limit voltage of 14V at 75° C. is carried out for six hours for the wound type cell of the fifth preferred embodiment and a rest time for six hours is set after discharging of high current for one second at 400 A. After this test, the temperature was set to a room temperature and a discharging was carried out at 500 A and the terminal voltage of the cell at the first second was measured. The wound type lead-acid battery of the fifth preferred embodiment enabled the terminal voltage of the cell to keep 10 V or more and it has been made apparent that it has a superior output performance even after the over-charging cycle at 75° C.

The engine driving system using the wound type lead-acid battery of the preferred embodiment 5 is operated such that the engine is stopped at the time of stopping for a red signal or a contemporary stopping and the engine is restarted with a motor when the vehicle starts to move in reference to improvement of a fuel consumption or a counter-measure of exhaust gas against global environment. When the wound type lead-acid battery of the preferred embodiment 5 is applied, a current is also flowed to an electrical load of the peripheral device installed on the vehicle in concurrent with supplying of current to the starter motor when it is restarted. In view of this fact, when the terminal voltage of the wound type lead-acid battery of the preferred embodiment 5 at the time of energization of the engine after idling operation under application of the idling stop system having the wound type lead-acid battery of the preferred embodiment 5 was measured, it was made apparent that the terminal voltage of the wound type lead-acid battery of the preferred embodiment 5 was 10 V or more and it was possible to keep the voltage where the peripheral device installed on the vehicle such as an audio system or the like is not stopped.

### COMPARATIVE EXAMPLE 1

In FIG. 10 is illustrated the first example of comparison of the wound type cell used in the engine driving system of the present invention.

The lead-acid battery 8 shown in FIG. 10 is constituted by a rectangular cell. This rectangular cell is manufactured by the following method. That is, at first, five cathode plates 100 and four anode plates 101 are laminated to each other through a separator 102 made of polyethylene with a thickness of 1.5 mm and the polarity plates of the same polarity are connected by a strap 103 to make a group of polarity plates 110. Further, six groups of the polarity plates 110 are connected in series in the electric housing 106 and arranged there, electrolysis solution of dilute sulfuric acid with a specific gravity 1.4 (20° C.) is poured to make a non-chemically-converted cell. After this item is chemically converted at 9 A for 20 hours and adjusted to become the electrolysis solution of sulfuric acid with a concentration of specific gravity 1.3 (20° C.). Then, the anode terminal 105 and the cathode terminal 104 are welded and a lid 107 is applied to make a hermetically sealed state and to attain a rectangular cell.

The cathode plate 100 of the lead-acid battery 8 formed by the rectangular cell shown in FIG. 10 is made such that at first the cathode assembly is manufactured, the cathode active substance paste is applied to coat on both front and rear surfaces of the cathode assembly and then the non-chemically-converted cathode plate is manufactured.

The cathode assembly is made such that alloy containing Sn of 1 wt % and Ca of 0.2 wt % is melted to Pb, thereafter they are cold rolled to make a rolled sheet with a thickness of 0.8 mm and expanded into the cathode assembly with a thickness of 1 mm.

The cathode active substance paste is a substance in which water of 12 wt % is added to mixture attained by mixing and kneading at a mixing and kneading machine for about ten minutes lignin of 0.3 wt %, barium sulfate or strontium sulfate of 0.2 wt %, carbon powder of 0.1 wt % and balance of lead powder, they are mixed and kneaded, dilute sulfuric acid of 13 wt % with a specific gravity 1.26 at 20° C. is added to the mixed and kneaded lead powder, and mixed and kneaded together.

Then, the non-chemically-converted cathode (cathode plate) 100 is made such that the cathode active substance paste of 45 g is filled in the cathode assembly with a thickness of 1 mm under application of the cathode assembly and the cathode active substance paste, left at a temperature of 50° C. and a humidity of 95% for 18 hours and ripened, thereafter they are left at a temperature of 110° C. for two hours, dried and formed to have a thickness of 1.3 mm.

The anode assembly is constituted such that alloy containing Sn of 1 wt % and Ca of 0.7 wt % is melted to Pb, thereafter the alloy is cold rolled to make a rolled sheet with a thickness of 0.2 mm and the anode assembly with a thickness of 1 mm is expanded.

The anode active substance paste is a substance in which water of 12 wt % is added to mixture attained by mixing and kneading at a mixing and kneading machine for about ten minutes lignin of 0.3 wt %, barium sulfate or strontium sulfate of 0.2 wt %, carbon powder of 0.1 wt % and balance of lead powder, they are mixed and kneaded, dilute sulfuric acid of 13 wt % with a specific gravity 1.26 at 20° C. is added to the mixed and kneaded lead powder, and mixed and kneaded together.

Then, the non-chemically-converted anode (anode plate) 101 is made such that the anode active substance paste of 45 g is filled in the anode assembly made of alloy containing Sn of 1 wt % at Pb with a thickness of 1 mm, left for 18 hours at a temperature of 50° C. and a humidity of 95% and ripened, thereafter they are left at a temperature of 110° C. for two hours, dried and formed to have a thickness of 1.6 mm.

A capacitance of the rectangular cell shown in FIG. 10 is 28 Ah and an average discharging voltage is 12V. In addition, the cell type is 38B19 and a volume of cell is 5.4 cm³. A total area of the anode at this time is 5,400 cm², an area of the anode per unit volume of the rectangular cell is 1,000 cm²/dm³ and an area of anode per cell is 900 cm².

At a graph B in FIG. 7 is indicated a current-voltage characteristic of the rectangular cell (comparative example 1) shown in FIG. 10. The current-voltage characteristic shown at the graph B in FIG. 7 is set such that a discharging current is changed to 100 to 500 A, the terminal voltage of the cell when discharging is carried out for one second from a state of full-charging is measured under application of a charging/discharging device. In accordance with the current-voltage characteristic at the graph B in FIG. 7, the rectangular cell (comparative example 1) shown in FIG. 10 indicates that discharging at the discharging current of 300 A or more causes the terminal voltage of the cell at the first second to be decreased substantially lower than 10 V and its output performance is deteriorated as compared with that of the wound type lead-acid battery of the preferred embodiment 3.

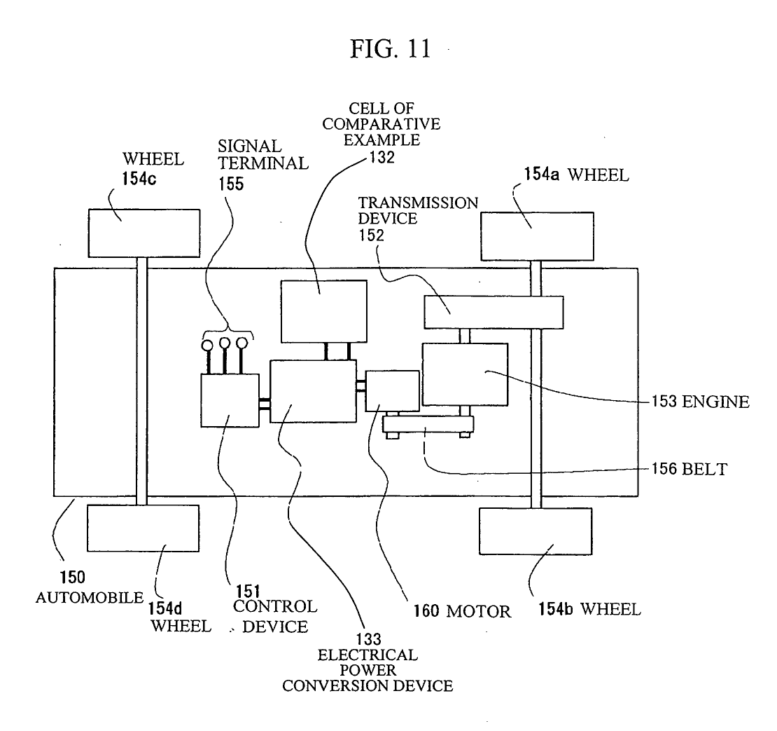

In FIG. 11 is shown one example of a configuration view in which the rectangular cell (comparative example 1) shown in FIG. 10 is used as a battery for the engine driving system employing the idling stop system for restarting the engine after driving the starter motor when the engine is stopped when the running of vehicle is stopped and when the running of the vehicle is started.

In FIG. 11, reference numeral 160 denotes a motor, reference numeral 132 denotes a rectangular cell shown in FIG. 10 of the comparative example 1, reference numeral 133 denotes a power converter, reference numeral 150 denotes an automobile, reference numeral 151 denotes a control device, reference 152 denotes a transmission device, reference numeral 153 denotes an engine, reference symbols 154a, 154b, 154c and 154d denote a wheel, reference numeral 155 denotes a signal terminal, and reference numeral 156 denotes a belt. The terminal voltage of the cell at the time of energization of the engine after idling operation was measured under application of the engine driving system shown in FIG. 11. The terminal voltage at the rectangular cell was a low value of 7.8V and the value was decreased down to such a voltage as one in which the peripheral device mounted on a vehicle such as an audio system and the like is stopped.

### COMPARATIVE EXAMPLE 2

The second example of comparison for the wound type cell used in the engine driving system of the present invention will be described as follows. A configuration of the wound type cell is the same as that of the wound type cell of the third preferred embodiment shown in FIG. 6.

The wound type cell of the second example of comparison is made such that the cathode plate 20 and the anode plate 21 are wound in a spiral form through the separator 22 as shown in the wound type cell shown in FIG. 3, six cells 60 formed into a column-like item are connected in series by the connecting terminals 63 and they are mounted in the external container 65 provided with the anode terminal 61 and the cathode terminal 62. A design capacity of the wound type cell of the second example of comparison is 20 Ah, this is lower as compared with that of the preferred embodiments 1, 2, 3, 4 and 5 and an average discharging voltage is 12V. In addition, when it is assumed that the maximum outer size of the wound type cell of the second example of comparison is a rectangular parallelepiped, it is the same as 38B19 and the cell capacity is 5.4 cm³. A total area of the electrode of the anode plate 21 of the wound type cell in the second example of comparison is a small value of 7,700 cm² and an anode area per unit volume of the wound type lead-acid battery is 400 cm²/dm³ and an anode area per a cell is 1,200 cm².

The cathode plate and the anode plate of the wound type cell of the second example of comparison were made in the same manner as that of the preferred embodiment 3. That is, the cathode plate of the wound type cell of the second example of comparison is made such that a cathode active substance paste of 45 g is applied to coat both surfaces of the cathode assembly made from a foil of alloy including Sn of 1.5 wt % to Pb with a thickness of 0.2 mm and it is formed into a thickness of 0.8 mm. In addition, the anode plate of the wound type cell of the second example of comparison is made such that an anode active substance paste of 45 g is applied to coat both surfaces of the anode assembly made from a foil of alloy including Sn of 1.5 wt % to Pb with a thickness of 0.2 mm and it is formed into a thickness of 0.8 mm.

Then, the cathode plate and the anode plate are wound in a spiral form through the separator 22 with a thickness of 0.9 mm, they are left at a temperature of 50° C. and at a humidity of 95% for 18 hours and ripened, thereafter they are left at a temperature of 110° C. for 2 hours and dried. After this operation, ten pole plate ears 23 of the same polarity are connected by the straps 24, the strap of each of the poles is welded to the cathode terminal 25 and the anode terminal 26 to make a wound group. This unit is installed in the electric housing 27, a lid 28 is applied to the top of it, melted, electrolysis solution of dilute sulfuric acid with a specific gravity 1.2 (20° C.) is poured through a liquid pouring hole 29 to make the non-chemically-converted cell. This is processed at 9 A for 20 hours, thereafter solution of dilute sulfuric acid with a specific gravity 1.4 (20° C.) is added and it is adjusted to become electrolysis solution of sulfuric acid with a concentration of specific gravity 1.3 (20° C.). Then, a safety valve 30 is installed there to attain a cell.

At a graph C in FIG. 7 is indicated a current-voltage characteristic of the wound type cell of the second example of comparison. The current-voltage characteristic indicated at the graph C in FIG. 7 shows that a discharging current is changed in 100 to 500 A in the same manner as that of the preferred embodiment 3 and the terminal voltage of the cell when the discharging is carried out for one second from the full charged state is measured by the charging/discharging device. In accordance with the current-voltage characteristic shown at the graph C in FIG. 7, it becomes apparent that the wound type cell of the second example of comparison indicates that discharging with a discharging current of 300 A or more causes the terminal voltage at the first second to be substantially decreased over 10 V and its output performance is deteriorated as compared with the wound type lead-acid battery of the preferred embodiment 3.

The wound type cell of the second example of comparison shows that a current flows to an electrical load of the peripheral device mounted on the vehicle in concurrent with supplying of current to the starter motor when a restarting operation is performed. Then, when the terminal voltage of the wound type cell of the second example of comparison when the engine is energized after idling operation under application of the idling stop system having the wound type cell in the second example of comparison used is measured, it becomes apparent that the terminal voltage of the wound type cell in the second example of comparison is lower than 10 V and a voltage can be kept where the peripheral device mounted on the vehicle such as an audio system and the like is not stopped.

### COMPARATIVE EXAMPLE 3

Then, there will be described about the third example of comparison of the wound type cell used in the engine driving system of the present invention. A constitution of the wound type cell is the same as that of the wound type cell of the third preferred embodiment shown in FIG. 6.

The wound type cell in the third example of comparison is constituted such that the cathode plate 20 and the anode plate 21 are wound in a spiral form through the separator 22 as found in the wound type cell shown in FIG. 3, six cells 60 formed into a column-like shape are connected in series by the connecting terminals 63, they are mounted at the external container 65 provided with the anode terminal 61 and the cathode terminal 62. A design capacitance of the wound type cell of the third example of comparison is 28 Ah that is similar to those of the preferred embodiments 1, 2, 3, 4 and 5 and an average discharging voltage is 12V. In addition, the maximum outer size of the wound type cell of the third example of comparison is 38B19 under an assumption that it is a rectangular parallelepiped and a cell volume is 5.4 dm³. A total area of the pole of the anode plate 21 of the wound type cell in the third example of comparison is 10,800 cm², an anode area per unit volume of the wound type lead-acid battery is 2,000 cm²/dm³ and an anode area per cell is 1,800 cm².

The wound type cell in the third example of comparison is constituted such that alloy containing Sn of 1 wt % is melted to Pb, thereafter the alloy is cold rolled to make a rolled sheet with a thickness of 0.2 mm and the cathode assembly is constituted by the rolled sheet with a thickness of 0.2 mm. In addition, the wound type cell in the third example of comparison is constituted such that alloy containing Sn of 1 wt % is melted to Pb, thereafter the alloy is cold rolled to make a rolled sheet with a thickness of 0.2 mm and the anode assembly is constituted by the rolled sheet with a thickness of 0.2 mm. The active substance paste is a substance in which water of 12 wt % is added to mixture attained by mixing and kneading at a mixing and kneading machine for about ten minutes lignin of 0.3 wt %, barium sulfate or strontium sulfate of 0.2 wt %, carbon powder of 0.1 wt % and balance of lead powder, they are mixed and kneaded, dilute sulfuric acid of 13 wt % with a specific gravity 1.26 at 20° C. is added to the mixed and kneaded lead powder, and mixed and kneaded together.

Then, the cathode plate and the anode plate are wound in a spiral form through the separator 22 with a thickness of 0.4 mm, they are left at a temperature of 50° C. and at a humidity of 95% for 18 hours and ripened, thereafter they are left at a temperature of 110° C. for 2 hours and dried. After this operation, ten pole plate ears 23 of the same polarity are connected by the straps 24, the strap of each of the poles 24 is welded to the cathode terminal 25 and the anode terminal 26 to make a wound group. This unit is installed in the electric housing 27, the lid 28 is applied to the top of it, melted, electrolysis solution of dilute sulfuric acid with a specific gravity 1.2 (20° C.) is poured through a liquid pouring hole 29 to make the non-chemically-converted cell. This is processed at 9 A for 20 hours, thereafter solution of dilute sulfuric acid with a specific gravity 1.4 (20° C.) is added and it is adjusted to become electrolysis solution of sulfuric acid with a concentration of specific gravity 1.3 (20° C.). Then, a safety valve 30 is installed there to attain a cell.

In addition, an over-charging test that is the most severe life test under an assumption of a high temperature environment when the wound type cell of the third example of comparison is installed at an engine room was carried out. As for the over-charging test at 75° C., 56 cycles (28 days) were repeated in which a constant current and constant voltage charging with a charging current of 5.6 A and an upper limit voltage of 14V at 75° C. is carried out for six hours for the wound type cell of the third example of comparison and a rest time for six hours is set after discharging of high current for one second at 400 A. After this test, the temperature was set to a room temperature and a discharging was carried out at 400 A and the terminal voltage of the cell at the first second was measured. The wound type cell of the third example of comparison enabled the terminal voltage of the cell to keep 7.5V but did not enable it to keep more than 10 V and its output performance was remarkably decreased after over-charging at 75° C.

Further, disassembling of the cell after its testing showed that pluralities of pole plate ears were kept cut. It might be considered that the pole plate ears were easily cut in the composition of the assembly in the third example of comparison because an intergranular corrosion was easily promoted, and the output performance was decreased.

### COMPARATIVE EXAMPLE 4

Then, there will be described about the fourth example of comparison of the wound type cell used in the engine driving system of the present invention. A constitution of the wound type cell is the same as that of the wound type cell of the third preferred embodiment shown in FIG. 6.

The wound type cell in the fourth example of comparison is constituted such that the cathode plate 20 and the anode plate 21 are wound in a spiral form through the separator 22 as found in the wound type cell shown in FIG. 3, six cells 60 formed into a column-like shape are connected in series by the connecting terminals 63, they are mounted at the external container 65 provided with the anode terminal 61 and the cathode terminal 62. A design capacitance of the wound type cell of the fourth example of comparison is 28 Ah that is similar to those of the preferred embodiments 1, 2, 3, 4 and 5 and an average discharging voltage is 12V. In addition, the maximum outer size of the wound type cell of the fourth example of comparison is 38B19 under an assumption that it is a rectangular parallelepiped and a cell volume is 5.4 dm³. A total area of the pole of the anode plate 21 of the wound type cell in the fourth example of comparison is 10,800 cm², an anode area per unit volume of the wound type lead-acid battery is 2,000 cm²/dm³ and an anode area per cell is 1,800 cm².

The wound type cell in the fourth example of comparison is constituted such that alloy containing Sn of 3 wt % is melted to Pb, thereafter the alloy is cold rolled to make a rolled sheet with a thickness of 0.2 mm and the cathode assembly is constituted by the rolled sheet with a thickness of 0.2 mm. In addition, the wound type cell in the fourth example of comparison is constituted such that alloy containing Sn of 3 wt % is melted to Pb, thereafter the alloy is cold rolled to make a rolled sheet with a thickness of 0.2 mm and the anode assembly is constituted by the rolled sheet with a thickness of 0.2 mm. The active substance paste is a substance in which water of 12 wt % is added to mixture attained by mixing and kneading at a mixing and kneading machine for about ten minutes lignin of 0.3 wt %, barium sulfate or strontium sulfate of 0.2 wt %, carbon powder of 0.1 wt % and balance of lead powder, they are mixed and kneaded, dilute sulfuric acid of 13 wt % with a specific gravity 1.26 at 20° C. is added to the mixed and kneaded lead powder, and mixed and kneaded together.

Then, the cathode plate and the anode plate are wound in a spiral form through the separator 22 with a thickness of 0.4 mm, they are left at a temperature of 50° C. and at a humidity of 95% for 18 hours and ripened, thereafter they are left at a temperature of 110° C. for 2 hours and dried. After this operation, ten pole plate ears 23 of the same polarity are connected by the straps 24, the strap of each of the poles 24 is welded to the cathode terminal 25 and the anode terminal 26 to make a wound group. This unit is installed in the electric housing 27, the lid 28 is applied to the top of it, melted, electrolysis solution of dilute sulfuric acid with a specific gravity 1.2 (20° C.) is poured through a liquid pouring hole 29 to make the non-chemically-converted cell. This is processed at 9 A for 20 hours, thereafter solution of dilute sulfuric acid with a specific gravity 1.4 (20° C.) is added and it is adjusted to become electrolysis solution of sulfuric acid with a concentration of specific gravity 1.3 (20° C.). Then, a safety valve 30 is installed there to attain a cell.

In addition, an over-charging test that is the most severe life test under an assumption of a high temperature environment when the wound type cell of the fourth example of comparison is installed at an engine room was carried out. As for the over-charging test at 75° C., 56 cycles (28 days) were repeated in which a constant current and constant voltage charging with a charging current of 5.6 A and an upper limit voltage of 14V at 75° C. is carried out for six hours for the wound type cell of the fourth example of comparison and a rest time for six hours is set after discharging of high current for one second at 400 A. After this test, the temperature was set to a room temperature and a discharging was carried out at 400 A and the terminal voltage of the cell at the first second was measured. The wound type cell of the fourth example of comparison enabled the terminal voltage of the cell to keep 8.2V but did not enable it to keep more than 10 V and its output performance was remarkably decreased after over-charging at 75° C.

Further, disassembling of the cell after its testing showed that the active substance was partly peeled off the assembly. It might be considered that a reason for this state consists in the fact that a composition of the assembly of the wound type cell in the fourth example of comparison has a low close fitting between the active substance and the assembly and the peeled-off active substance may not perform a roll of discharging reactive substance to cause an output performance to be decreased.

In this way, the engine driving system employing the idling stop system in which an engine is stopped at the time of stopping running of a vehicle, a starter motor is driven at the time of starting running of the vehicle and an engine is re-energized requires to attain the most suitable configuration and structure of the cell in which a high output is produced by the lead-acid battery and no reduction in battery voltage occurs also at the time of restarting of the engine, and in order to attain this state, it is necessary to expand an area of the pole plate, its compact formation is required for its installation at an engine room and so a thin pole plate formation is required. In accordance with the preferred embodiments of the present invention, as a battery for the engine driving system provided with the idling stop device for stopping the engine at the time of stopping vehicle and restarting the engine at the time of starting running of the vehicle, i.e. as a power supply for supplying an electrical power to the motor for rotationally driving the engine at the time of restarting of the engine and supplying an electrical power to the peripheral devices mounted on the vehicle, it can be realized by using the wound type lead-acid battery in which there are provided a group of pole plates having the anode plate and cathode plate wound in a spiral form through the separator and the group of the pole plates hold electrolysis solution.

The cell can be roughly classified into two groups in reference to its shape, one of them is a rectangular one which is widely distributed in general as a UPS usage or an automobile and the other is a cylindrical one. The former is a laminated type lead-acid battery in which a predetermined number of anode plates and cathode plates are alternatively laminated with the separator being placed between the pole plates while active substance being filled in a flat plate assembly and they are inserted into a rectangular electrical housing. Thin formation of the pole plates in the laminated type lead-acid battery causes the active substance to be easily dropped off because no pressure is applied to the pole plates in view of their structure. Due to this fact, there was a certain limitation for making a thin pole plate and expanding an area of the pole plate. The latter is a wound type lead-acid battery constituted by the cells in which the anode plate and the cathode plate having active substance filled in the band-like assembly are wound in a spiral form with the band-like separator being placed between the pole plates and they are inserted into a cylindrical case. Even if the pole plates in the wound type lead-acid battery are made thin, the active substance is scarcely dropped off because a certain winding pressure is applied to the pole plates. Accordingly, it is possible to expand to the most-suitable pole plate area for attaining an output performance where the battery voltage is not decreased even at the time of restarting of the engine.

In accordance with the preferred embodiments of the present invention, it becomes necessary to drive the motor with a current of 400 A or more although in a short period of time for restarting the engine operated in idling mode. Even if the current of 400 A or more is outputted at the wound type lead-acid battery of the present invention, the terminal voltage can maintain 10 V or more. Normally, the voltage where the peripheral devices mounted on an automobile can not stop but operate stably is 10 V or more. Accordingly, the engine driving system using the wound type lead-acid battery of the present invention shows that the peripheral devices mounted on the automobile are not stopped, but the restarting in operation of the engine can be carried out.

In addition, when the prior-art laminated type lead-acid battery is used as a power supply for the engine driving system provided with the idling stop system, in contrast to the fact that it requires the volume of twice or more of the prior art volume for keeping a voltage in which the peripheral devices mounted on the automobile are not stopped but can be operated stably, the present preferred embodiments enable the cell to be installed in the engine room because the cell volume is not increased more than that of the prior art.

A reason why an area of the anode plate per cell is 1,500 to 27,000 cm² and an area per unit volume under an assumption that the maximum outer size of the wound type lead-acid battery is a rectangular parallelepiped is 1,700 to 30,000 cm²/dm³ in the preferred embodiments of the present invention consists in the fact that it is hard to maintain the terminal voltage more than 10 V even if the current of 400 A or more is outputted when the area of the anode plate per cell is lower than 1,500 cm² and an area per a unit volume is lower than 1700 cm²/dm³.

A thickness of the separator is closely related with an area of the pole plate and a volume of separator occupied in a limited cell space is increased due to the thick separator, so that the volume of the pole plates is correspondingly decreased and the area of the pole plates is also decreased. Accordingly, if the separator thickness is thick, it is hard to attain the cell configuration where a reduction in battery cell does not occur at the time of restarting in operation of the engine. Due to this fact, a range of 0.01 to 0.6 mm is the most desirable one for the separator thickness to attain a configuration of the cell where no reduction in battery voltage occurs at the time of restarting the engine.

A reason why tin of 1.3 wt % or more and 2.3 wt % or less is contained as a composition of alloy of the assembly included in the anode plate and the balance is lead and unavoidable impurities in the preferred embodiments of the present invention consists in the fact that it is preferable to use the assembly having composition of alloy having a stress corrosion hardly promoted. That is, in contrast to the fact that the active substance is not peeled off even if the pole plate is made thin because a specified winding pressure is applied to the pole plate in the wound type lead-acid battery, the assembly constituting the anode plate easily generates a stress corrosion. In particular, when it is used in the engine room, the stress corrosion of the assembly is accelerated because it is placed under a high temperature environment exceeding 60° C. In addition, when it is used as a power supply for the idling stop system, an output of high current to the motor and an input of high current from a generator are frequently carried out every time an automobile stops. Repeating of such inputting and outputting under a high current becomes a cause for promoting local corrosion for the assembly, so that the stress corrosion becomes further easily promoted. When the stress corrosion of the assembly is promoted, a resistance at the assembly is increased or the assembly is broken, so that an electrical accumulating performance is damaged and the output performance is substantially decreased. The most-suitable setting of composition of alloy of the assembly has been studied in the wound type lead-acid battery where a winding pressure is applied to the pole plate as a power supply for the idling stop system where an outputting of high current to the motor and an inputting of high current from the generator are repeated every time an automobile is stopped under a high temperature condition at 75° C. As a result, it has become apparent that the most superior output performance can be attained by lead-tin alloy containing Sn of a range of 1.3 wt % or more to 2.3 wt % or less.

The composition of alloy where the content of Sn is lower than 1.3 wt % showed that a stress corrosion of the assembly can be easily promoted to cause a resistance of the assembly to be increased or the assembly to be damaged, so that the electrical accumulating performance was damaged and the output performance was substantially decreased. In turn, the composition of the alloy where a content of Sn was higher than 2.3 wt %, a close fitness of the active substance and the assembly was poor, so that an interface resistance between the active substance and the assembly was increased and the output performance was substantially decreased.

As described above, using the engine driving system of the present invention enables a less-expensive simple configuration having no additional power supply to be attained and further enables a stable operation of the peripheral device mounted on the vehicle to be carried out even if the idling stopped state is carried out. Further, it is possible to expand a vehicle space corresponding to no space for the additional power supply because the power supply can be installed in the engine room.

1. An engine driving system in which an engine is stopped at the time of stopping running of a vehicle and the engine is restarted at the time of starting running of the vehicle, wherein
there are provided an engine electronic control device for controlling said engine, a motor for restarting said engine and a cell for supplying an electrical power to said motor;
said cell comprises an anode plate formed into a thin band-shape, a cathode plate formed into a thin band-shape and a band-like separator arranged between said anode plate and said cathode plate; and
said anode plate, said cathode plate and said separator form a group of wound pole plates and said group of pole plates is immersed in electrolysis solution.

2. The engine driving system according to claim 1, wherein said cell is a wound type cell formed into a spiral cylindrical shape.

3. The engine driving system according to claim 1, wherein said cell has a function for outputting a voltage of 10 V or more even if a current of at least 400 A is outputted.

4. The engine driving system according to claim 1, wherein said anode plate is one in which anode active substance paste is applied to coat both front and rear surfaces of an assembly constituted by a rolled sheet of Pb—Sn alloy and chemically converted.

5. The engine driving system according to claim 1, wherein an area of said anode plate is 9,000 to 162,000 cm².

6. The engine driving system according to claim 4, wherein a content of Sn in Pb—Sn alloy constituting said assembly is 1.3 wt % or more and 2.3 wt % or less.

7. The engine driving system according to claim 1, wherein a thickness of said separator is 0.01 to 0.6 mm.

8. An engine driving system in which an engine is stopped at the time of stopping running of a vehicle and the engine is restarted at the time of starting running of the vehicle, wherein
there are provided an engine electronic control device for controlling said engine, a motor for starting said engine and a cell for supplying an electrical power to said motor;
said cell comprises a plurality of cells connected in series;
each of the cells comprises an anode plate formed into a thin band-shape, a cathode plate formed into a thin band-shape and a separator formed into a band-shape between said anode plate and said cathode plate; and
said anode plate, said cathode plate and said separator are wound to form a group of wound pole plates and said group of pole plates is immersed in electrolysis solution.

9. The engine driving system according to claim 8, wherein said cell is formed into a spiral cylindrical shape.

10. The engine driving system according to claim 8, wherein said cell has a function for outputting a voltage of 10 V or more even if a current of at least 400 A is outputted.

11. The engine driving system according to claim 8, wherein the anode plate of said cell is one in which anode active substance paste is applied to coat both front and rear surfaces of an assembly constituted by a rolled sheet of Pb—Sn alloy and chemically converted.

12. The engine driving system according to claim 8, wherein an area of the anode plate of said cell is 1,500 to 27,000 cm² and an area per unit volume under an assumption that the maximum outer size of said lead-acid battery is a rectangular parallelepiped is 1,700 to 30,000 cm²/dm³

13. The engine driving system according to claim 11, wherein a content of Sn in Pb—Sn alloy constituting said assembly is 1.3 wt % or more and 2.3 wt % or less.

14. The engine driving system according to claim 8, wherein a thickness of said separator is 0.01 to 0.6 mm.

15-21. (canceled)
